(19) United States
(12) Patent Application Publication
(10) Pub. No.: US 2010/0030882 A1
(43) Pub. Date: Feb. 4, 2010

(54) MANAGEMENT APPARATUS, COMMUNICATION APPARATUS, CONTROL METHOD, AND PROGRAM

(75) Inventor: Masashi Hamada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/511,010

(22) Filed: Jul. 28, 2009

(30) Foreign Application Priority Data
Jul. 31, 2008 (JP) 2008-197966

(51) Int. Cl. G06F 15/173

(52) U.S. Cl. 709/223

(57) ABSTRACT

It has been difficult for a management apparatus to make a communication apparatus change a communication channel in consideration of a remaining communication band of a network so as to set an appropriate communication channel. Further, setting the appropriate communication channel has been an enormous load placed on a communication apparatus provided with not many processing resources including a small CPU capacity, a small memory, and so forth. Therefore, the present invention allows for setting an appropriate communication channel ready for the remaining communication band of the network. Further, the present invention allows for reducing the load placed on the communication apparatus for setting the appropriate communication channel. Therefore, a management apparatus managing the network determines a communication channel satisfying a requested communication band and notifies at least a transmission apparatus and/or a reception apparatus of a change to the communication channel.

### BACKGROUND OF THE INVENTION

1. Field of the Invention

The present invention relates to a technology for setting a communication channel on a network.

2. Description of the Related Art

UPnP QoS disclosed in non-patent document 1 has been used as a method of allocating a communication band for each of communication paths included in a communication channel on a packet communication network including a LAN or the like. Here, the term “LAN” is an abbreviation for “Local Area Network”. Further, the term “UPnP” is an abbreviation for “Universal Plug and Play”, and the term “QoS” is an abbreviation for “Quality of Service”.

Further, a distributed control technology has been achieved so that a communication apparatus applies to an access-point management server for the use status of the communication band of each access point, and determines a change of the access point on its own initiative based on the use status of the communication band.

In the past, however, a change of the communication channel was determined by confirming the use status of a communication band between each communication apparatus and an apparatus to which the communication apparatus is directly connected.

Therefore, it has been difficult to set a communication channel for which a communication band is allocated between a data transmission apparatus and a data reception apparatus based on the use status of a communication band used in the network. Further, even though each communication apparatus has been made to determine the change of the communication channel, making the above-described determination has become burdensome to a communication apparatus provided with not many processing resources including a small central-processing-unit (CPU) capacity, a small memory, and so forth.

### SUMMARY OF THE INVENTION

Accordingly, the present invention has been achieved to set a communication channel for which a communication band is allocated between a data transmission apparatus and a data reception apparatus.

Further features of the present invention will become apparent from the following description of exemplary embodiments with reference to the attached drawings.

### BRIEF DESCRIPTION OF THE DRAWINGS

FIG. 1 is a system configuration diagram.

FIG. 2 is a functional block diagram of a management apparatus.

FIG. 3 is a functional block diagram of a source node.

FIG. 4 is an illustration of communication channels.

FIG. 5 is a sequence chart.

FIG. 6 shows a remaining communication band of each of communication paths.

FIG. 7 is a flowchart of processing procedures performed by the management apparatus.

FIG. 8 is a flowchart of processing procedures performed by a communication apparatus.

FIG. 9 is another system configuration diagram.

FIG. 10 is another sequence chart.

FIG. 11 is another system configuration diagram.

FIG. 12 is another sequence chart.

FIG. 13 shows a remaining communication band of each of communication paths.

FIG. 14 is a flowchart of processing procedures performed by the communication apparatus.

### DESCRIPTION OF THE EMBODIMENTS

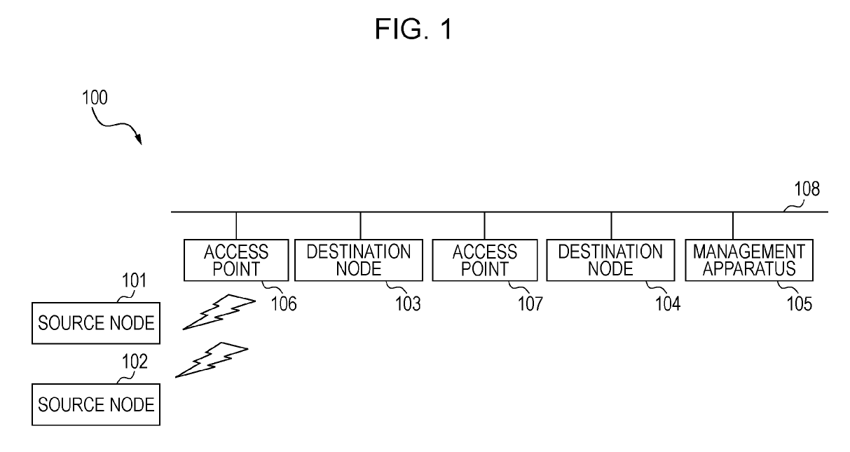

FIG. 1 shows the configuration of a packet communication network system (LAN) 100 according to a first embodiment of the present invention.

The LAN 100 includes a plurality of communication apparatuses and management apparatuses, and a plurality of access points. Communication apparatuses 101 and 102 include, for example, a camera, a content server, and so forth that are provided to store data used to perform streaming communications. Hereinafter, each of the communication apparatuses 101 and 102 is referred to as a source node. Further, the above-described communication apparatus may be a communication adapter connected to a camera and/or a content server. Here, the data used to perform the streaming communication data may be, for example, movie data. Each of communication apparatuses 103 and 104, which are provided to receive data transmitted through the streaming communications, may include a display or the like. Hereinafter, each of the communication apparatuses 103 and 104 will be referred to as a destination node. Each of the above-described communication apparatuses 103 and 104 may be a communication adapter connected to the display.

A management apparatus 105 is provided to manage network information obtained in a system (the LAN 100 in the above-described embodiment). Here, the network information includes information about the communication apparatus provided on the LAN 100, information indicating between what communication apparatuses a communication path can be set and/or between what communication apparatus and an access point the communication path can be set, and information about the communication band of each of communication paths. The management apparatus may be not only a personal computer (PC) and/or a server, but also information equipment having a CPU with a sufficient capacity, such as a television, where the information equipment includes the source node and/or the destination node of the above-described embodiment.

Each of access points 106 and 107 is ready for the standard IEEE 802.1p. Here, the term “IEEE” is an abbreviation for “The Institute of Electrical and Electronics Engineers, Inc.”. A wired communication channel 109 is provided to connect the communication apparatuses 103 and 104, the management apparatus 105, and the access points 106 and 107 to one another.

According to the LAN 100, a communication band is allocated for each of communication paths included in the communication channel based on Request Traffic QoS (hereinafter referred to as a communication-channel allocation request) determined on the basis of UPnP QoS. Here, the communication-channel allocation request denotes a message transmitted from the communication apparatus to the management apparatus, so as to request the management apparatus to set a communication channel for which a communication band is allocated over the entire area extending between the communication apparatuses (End-to-End). Further, each of the link between the source node 102 and the access point 105, and that between the access point 106 and the destination node 104 is referred to as a communication path. A combination of the above-described communication paths, which extends from the source node 102 to the destination node 104 via the access point 106, is referred to as a communication channel.

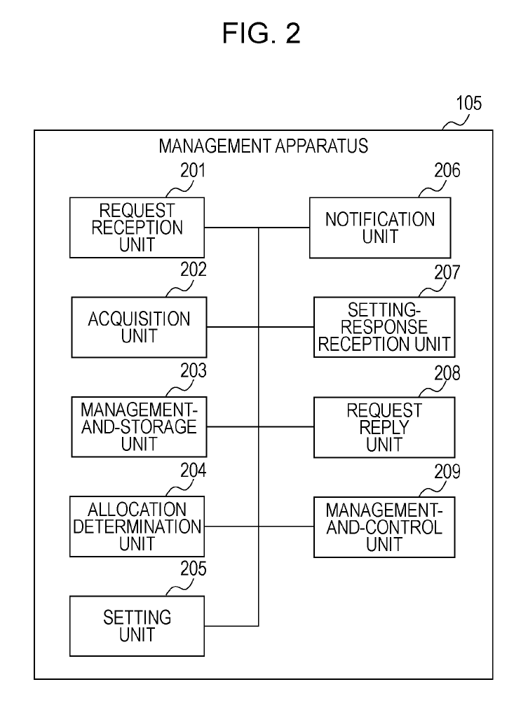

FIG. 2 is a functional block diagram of the management apparatus 105 including a request reception unit 201 configured to receive the communication-channel allocation request, an acquisition unit 202 configured to acquire information about the remaining communication band of each of the communication paths provided in the system, where the remaining communication band denotes a band remaining and unused to perform communications, a management-and-storage unit 203 configured to store information about the remaining communication band provided in the system and a program configured to perform processing procedures shown in a flowchart which will be described later, and an allocation determination unit 204 that refers to the information about the remaining communication band provided in the system and that determines whether a communication band requested for the communication channel can be allocated.

The management apparatus 105 also includes a setting unit 205 configured to set change information, as additional information, to Setup Traffic QoS (hereinafter referred to as a setting message) determined based on UPnP QoS. Here, the setting message denotes a message transmitted to instruct each of the communication apparatuses and the access points that are ready for the UPnP QoS to allocate the communication band. Further, the change information denotes information about change control performed by the communication apparatus, so as to set a communication channel for which a requested communication band is allocated. The change control performed by the communication apparatus includes changing the communication channel and/or changing the transfer rate of different communications that had already been performed.

A notification unit 206 is configured to transmit the setting message to each of the communication apparatuses provided on the communication channel. The setting message includes information about a communication band allocated by each of the communication apparatuses and the access points. A setting response reception unit 207 is configured to receive a response to the setting message, the response being transmitted from each of the communication apparatuses. A request reply unit 208 is configured to reply to the communication-channel allocation request. A management-and-control unit 209 is configured to execute processing procedures shown in a flowchart that will be described later.

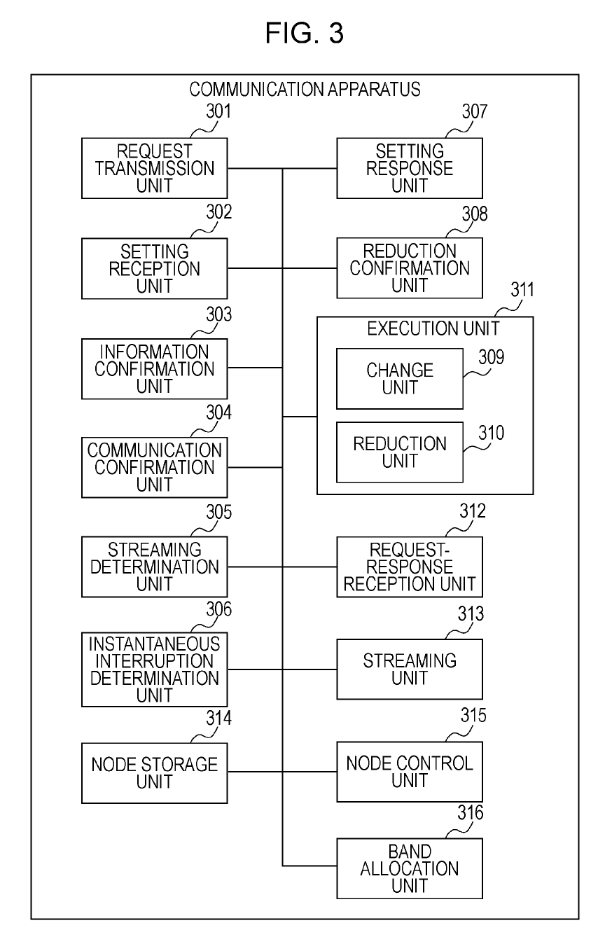

FIG. 3 is a functional block diagram of the communication apparatus included in the LAN 100. In the first embodiment, the source node 102 will be exemplarily described as the communication apparatus.

A request transmission unit 301 is configured to transmit a communication-channel allocation request. A setting reception unit 302 is configured to receive a setting message. An information confirmation unit 303 is configured to confirm change information set to the setting message as additional information. A communication confirmation unit 304 is configured to confirm whether a communication can be established between the source node 102 and an access point provided at a change destination. A streaming determination unit 305 is configured to determine whether the streaming communication had already been performed after determining an own node (the source node 102 in the first embodiment) to be a transmission apparatus or a reception apparatus or a relay apparatus.

An instantaneous-interruption determination unit 306 is configured to determine whether the communication can be instantaneously interrupted. The above-described instantaneous interruption denotes a temporary shutdown of the communication, where the shutdown occurs when the own node (the source node 102 in the first embodiment) changes the access point. A setting response unit 307 is configured to transmit a response to the setting message. A transfer-rate confirmation unit 308 is configured to confirm whether the transfer rate of the different communication that had already been performed can be reduced to a specified transfer rate. A change unit 309 is configured to change the connection destination of the own node (the source node 102 in the first embodiment) based on the change information set to the setting message as the additional information. A reduction unit 310 is configured to reduce the transfer rate of the different communication that had already been performed to the specified transfer rate. An execution unit 311, which includes the change unit 309 and the reduction unit 310, is configured to execute processing based on the change information when the execution unit 310 accepts the change information.

A request-response reception unit 312 is configured to receive a response to the communication-channel allocation request. A streaming unit 313 is configured to perform the streaming communication. A node storage unit 314 is configured to store a program provided to execute processing procedures shown in a flowchart which will be described later. A node control unit 315 is configured to execute the processing procedures shown in the flowchart which will be described later. A band allocation unit 316 is configured to allocate a communication band conforming to the UPnP Qos standard.

The access points 106 and 107 may not conform to the UPnP QoS standard. Since each of the above-described access points may not conform to the UPnP QoS standard, the flexibility of the system configuration can be increased.

In the first embodiment, the access point does not conform to the UPnP QoS standard (even though the access point conforms to the standard IEEE 802.1p).

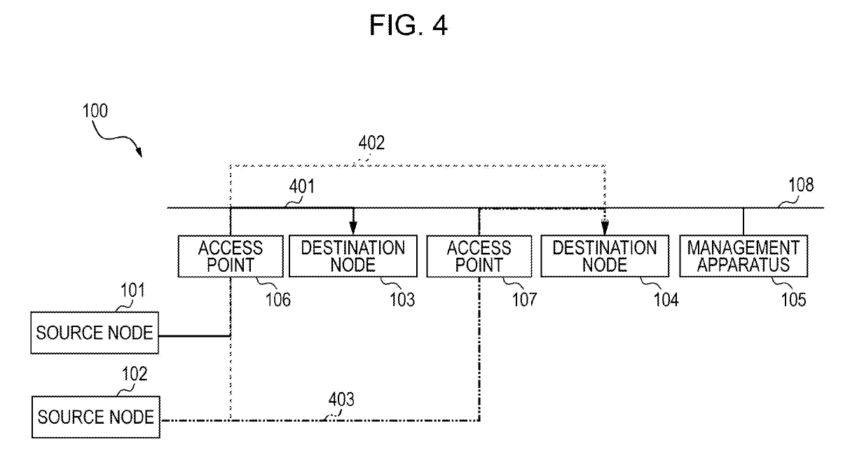

FIG. 4 illustrates the communication channel provided in the LAN 100. A communication channel 401 is a communication channel for which a band is allocated, where the communication channel extends from the source node 101 to the destination node 103 via the access point 106. The streaming communication is performed between the source node 101 and the destination node 103 through the communication channel 401 by using a communication band of 30 Mbps.

A communication channel 402 is a communication channel for which no band is allocated, where the communication channel 402 extends from the source node 102 to the destination node 104 via the access point 106. The source node 102 communicates with the destination node 104 through the communication channel 402.

A communication channel 403 is set as a different communication channel for which a band is allocated, where the communication channel 403 extends from the source node 102 to the destination node 104 via the access point 107. The different communication channel 403 is set in response to a request to start a different streaming communication, where the request is issued, for example, in the source node 102 based on an instruction of a higher-layer application and/or the operation of a user.

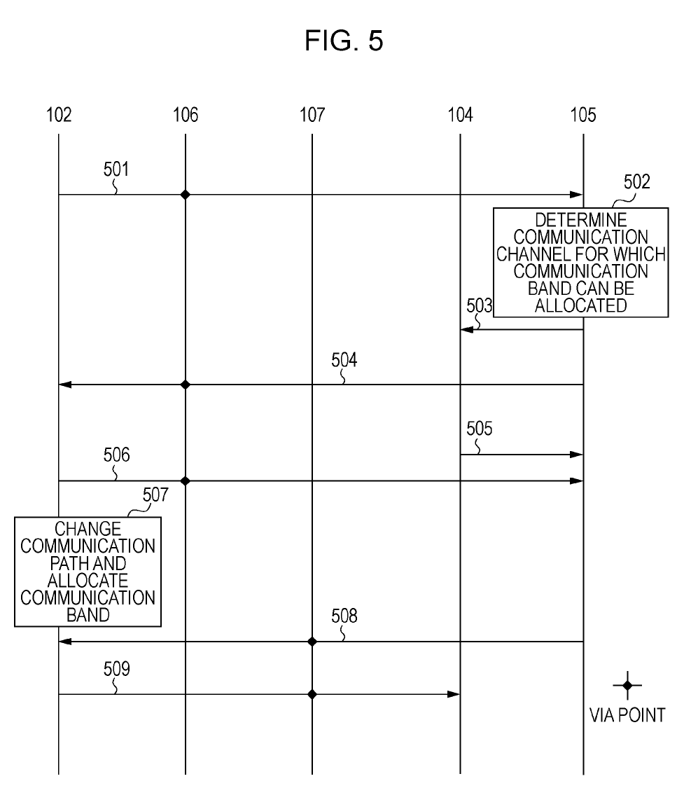

FIG. 5 shows a sequence chart illustrating an example where the different communication channel 403 is allocated. First, the source node 102 transmits a communication-channel allocation request 501 to the management apparatus 105. Upon receiving the communication-channel allocation request 501, the management apparatus 105 refers to information about communication bands remaining in the LAN 100 and the communication channel 403 is used. Consequently, it is determined that a requested communication band can be allocated over the entire area extending between the communication apparatuses (End-to-End) (502).

Then, the setting messages 503 and 504 are transmitted to each of the communication apparatuses provided on the communication channel 403 (the source node 102 and the destination node 104 in this case). Since the access point 107 does not conform to the UPnP QoS standard, the setting messages 503 and 504 are not transmitted to the access point 107. The change information is set to the setting message 504 as additional information so as to be ready for the different communication channel 403.

Upon receiving the setting message, the communication apparatuses transmit responses 505 and 506 indicating that the setting message is accepted to the management apparatus 105 when the communication band can be allocated based on the setting message. After that, the source node 102, which had transmitted the response 506, switches to another communication path, so as to be ready for the different communication channel 403 based on the change information set to the setting message. More specifically, the source node 102 changes the connection destination from the access point 106 to the access point 107. Further, the source node 102 allocates a communication band based on the setting message (507).

Upon receiving the acceptance responses 505 and 506 as responses to the setting message, the management apparatus 105 confirms that the source node 102 changes the communication path and transmits a response 508 indicating that the communication-channel allocation request is accepted to the source node 102, which had issued the communication-channel allocation request.

Upon receiving the response 508 indicating that the communication-channel allocation request is accepted, the source node 102, which had issued the communication-channel allocation request, confirms that the communication-channel allocation request is accepted. Further, the source node 102 determines that the different communication channel 403 is successfully allocated, and starts performing a streaming communication 509.

As described above, the management apparatus refers to the information about the communication bands remaining in the LAN, and instructs the communication apparatus to set a communication channel for which a requested communication band can be allocated. Consequently, the communication channel for which the communication band is allocated is set over the entire area extending between the communication apparatuses (End-to-End). Therefore, the streaming communication can be performed through the communication channel for which an appropriate communication band is allocated in the entire section between the source node and the destination node (End-to-End).

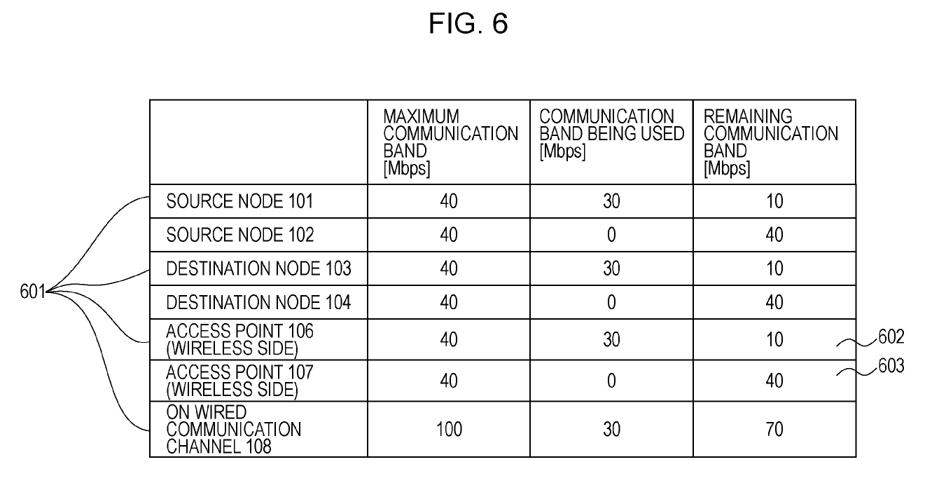

FIG. 6 is a diagram showing the remaining communication band of each of the communication apparatuses and the access points provided in the LAN 100, where the information about the remaining communication bands is stored in the management-and-storage unit 203. The communication band of 30 Mbps is allocated for each of the communication apparatuses and the access points that are provided on the communication channel 401 (601). As a result, the access point 106 has a remaining communication band of 10 Mbps, as a wireless communication band (602). Further, the access point 107, for which no communication band is allocated, has a remaining communication band of 40 Mbps, as the wireless communication band (603).

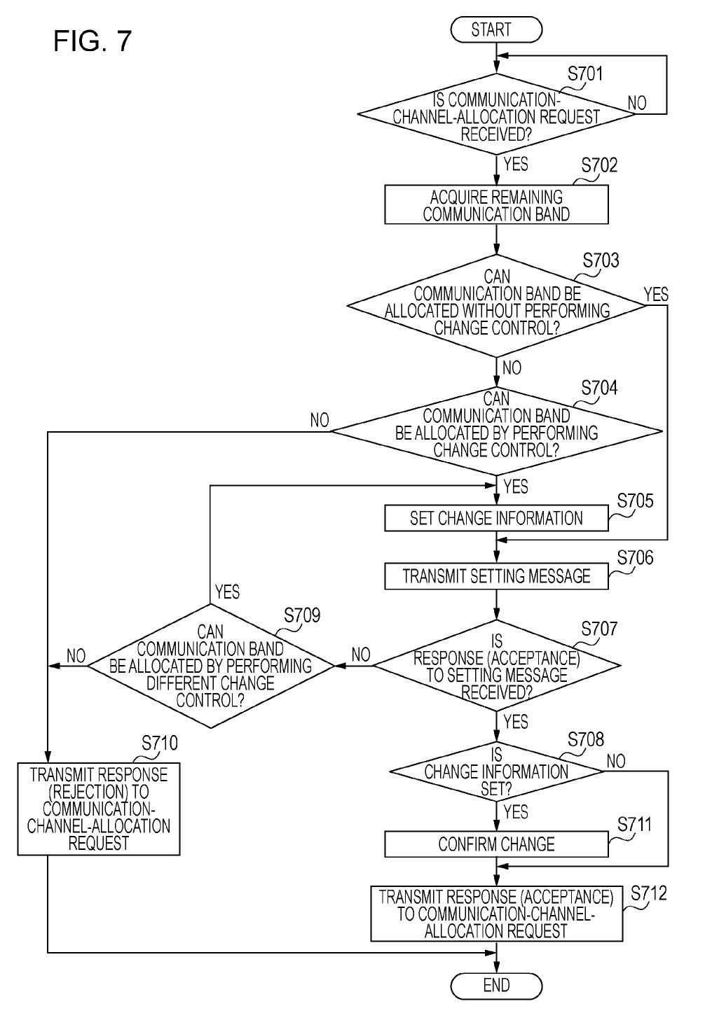

FIG. 7 is a flowchart illustrating control performed through the management-and-control unit 209 so as to allocate a different communication channel 403. A program provided to perform the above-described control is stored in the management-and-storage unit 203.

First, at step S701, the management-and-control unit 209 confirms whether or not the request-reception unit 201 receives the communication-channel allocation request 501 transmitted from the source node 102. If the communication-channel allocation request 501 is received, the processing advances to step S702 where it is requested that a communication channel for which a communication band of 20 Mbps is allocated be set from the source node 102 to the destination node 104 due to the communication-channel allocation request 501.

Next, at step S702, the management-and-control unit 209 makes the acquisition unit 202 refer to data stored in the management-and-storage unit 203 and acquire information about the remaining communication band of each of the communication apparatuses and the access points that are provided in the LAN 100, where the information is shown in FIG. 6. The remaining-communication-band information may be acquired by applying to each of the communication apparatuses. At that time, the remaining-communication-band information of each of the access points 106 and 107 can be acquired by applying to each of the communication apparatuses connected to the access points. This is because the remaining communication band can be obtained by subtracting the value of the sum of the communication bands used by all of the communication apparatuses connected to an access point from the value of the maximum communication band of the access point.

In the first embodiment, the remaining-communication-band information is acquired by applying to the source nodes 101 and 102. Further, when the management apparatus 105 connected to the wired communication channel 108 is connected to, for example, Gigabit Ethernet, it is determined that the wired communication channel 108 has a communication band of 1 Gbps so that the communication band information of the wired communication channel 108 can be acquired.

Next, at step S703, the management-and-control unit 209 makes the allocation determination unit 204 determine whether or not the communication channel 402, which extends from the source node 102 to the destination node 104 before a change is made, satisfies a requested communication band based on the acquired remaining-communication-band information. In this case, it is determined that the requested communication band can be allocated when all of communication paths included in the communication channel 402, that is, the value of the remaining communication bands of all of the communication apparatuses and all of the access points is higher than that of the requested communication band.

If it is determined that the requested communication band can be allocated by using the communication channel 402 used before the change is made without changing the communication channel, the processing advances to step S706. If it is determined that the requested communication band can be allocated with difficulty, the processing advances to step S704.

Consequently, if the requested communication band can be allocated without changing the communication channel, the communication channel is not changed. Therefore, it becomes possible to set a communication channel for which a communication band is allocated within a short time period. Further, since each of the communication apparatuses can set the communication channel for which the communication band is allocated without changing the connection destination, the communication apparatuses can set a communication channel for which a communication band is allocated under reduced load within a short time period.

In the first embodiment, the destination node 104 and the wired communication channel 108 can allocate a requested communication band of 20 Mbps, as shown in FIG. 6. However, since a communication band of 30 Mbps is allocated on the communication channel 401 by the source node 101, the communication band between the source node 102 and the access point 106 becomes insufficient. Therefore, the communication band of the communication channel 402 becomes insufficient so that the communication channel is allocated with difficulty.

At step S704, the management-and-control unit 209 instructs the allocation determination unit 204 to make the communication apparatus perform the change control. Consequently, the allocation determination unit 204 selects a communication channel for which a requested communication band can be allocated. In the above-described embodiment, the allocation determination unit 204 selects the communication channel 403 for which the requested communication band can be allocated by making the communication apparatus change the communication path. Here, it is determined that the requested communication band can be allocated when the value of the remaining communication bands of all of communication paths, the value being obtained after the communication path is changed, is higher than that of the requested communication band. At that time, the management apparatus 105 manages the network information obtained in the LAN 100. Therefore, it is determined that the requested communication band can be allocated over the entire area by using the communication channel 403 (502).

If the requested communication band can be allocated by using a communication channel obtained after the change is made, the processing advances to step S705. If the requested communication band is allocated with difficulty, the processing advances to step S710.

In this case, there is a sufficient remaining communication band for the access point 107, so as to provide the requested communication band as shown in FIG. 6. Therefore, it is determined that the requested communication band can be allocated by using the communication channel 403 including a changed communication path on the source-node-102 side. Then, the processing advances to step S705.

At step S705, the management-and-control unit 209 makes the setting unit 205 set the change information to the setting message as the additional information. The change information includes the change information of the communication path and information about the address of the change destination. In this embodiment, information is set to the setting message 503 as the communication-path change information so that the access point used by the source node 102 is changed from the access point 106 to the access point 107. The MAC address and/or the IP address of the access point 107 is set as the address of the change destination. Additionally, a service set identifier (SSID) used to change the access point, an encryption method, an encryption key, and so forth can be set to the change information.

At step S706, the management-and-control unit 209 makes the notification unit 206 transmit the setting message to each of the communication apparatuses and the access points that are provided on another set communication channel (the communication channel 403 in this case). In the above-described embodiment, the setting message is not transmitted to the access point 107 since the access point 107 does not conform to the UPnP QoS standard. Here, the setting message 503 is transmitted to the destination node 104 and the setting message 504 is transmitted to the source node 102 via the access point 106. Change information which is an instruction for supporting the different communication channel 403 is set to the setting message 504 at step S705.

At step S707, the management-and-control unit 209 confirms whether or not the setting-response reception unit 207 receives an acceptance response to the setting message, the response being transmitted from each of the communication apparatuses. If the acceptance response transmitted from each of the communication apparatuses and the access points to which the setting message is transmitted at step S706 (only the communication apparatuses in that case) are received, the processing advances to step S708. In that case, the acceptance responses 505 and 506 that are transmitted from the communication apparatuses are received so that the processing advances to step S708.

At step S708, the management-and-control unit 209 determines whether the change information is set at step S705. If the change information is set, the processing advances to step S711. Otherwise, the processing advances to step S712. In the first embodiment, the change information is set at step S705. Therefore, the processing advances to step S711.

At step S711, the management-and-control unit 209 confirms whether or not the communication channel is changed based on the change information set at step S705. After confirming the change, the processing advances to step S712.

At step S712, the management-and-control unit 209 makes the request reply unit 208 transmit the acceptance response 506 as a response to the communication-channel allocation request.

On the other hand, if no response is received and/or a rejection reply message is received at step S707, the processing advances to step S709. At step S709, the management-and-control unit 209 makes the allocation determination unit 204 determine whether or not the requested communication band can be allocated by making the communication apparatus perform different change control. In the above-described embodiment, the allocation determination unit 204 makes the communication apparatus change to a communication path which had not been determined, and determines whether or not the requested communication band can be allocated by using the changed communication channel. If the requested communication band can be allocated by using the changed communication channel, the processing advances to step S705. Otherwise, the processing advances to step S710.

At step S710, the management-and-control unit 209 makes the request reply unit 208 transmits the rejection response as a response to the communication-channel allocation request.

In this embodiment, a response message indicating acceptance is transmitted from each of the communication apparatuses and the acceptance response 508 is transmitted as a response to the communication-channel allocation request.

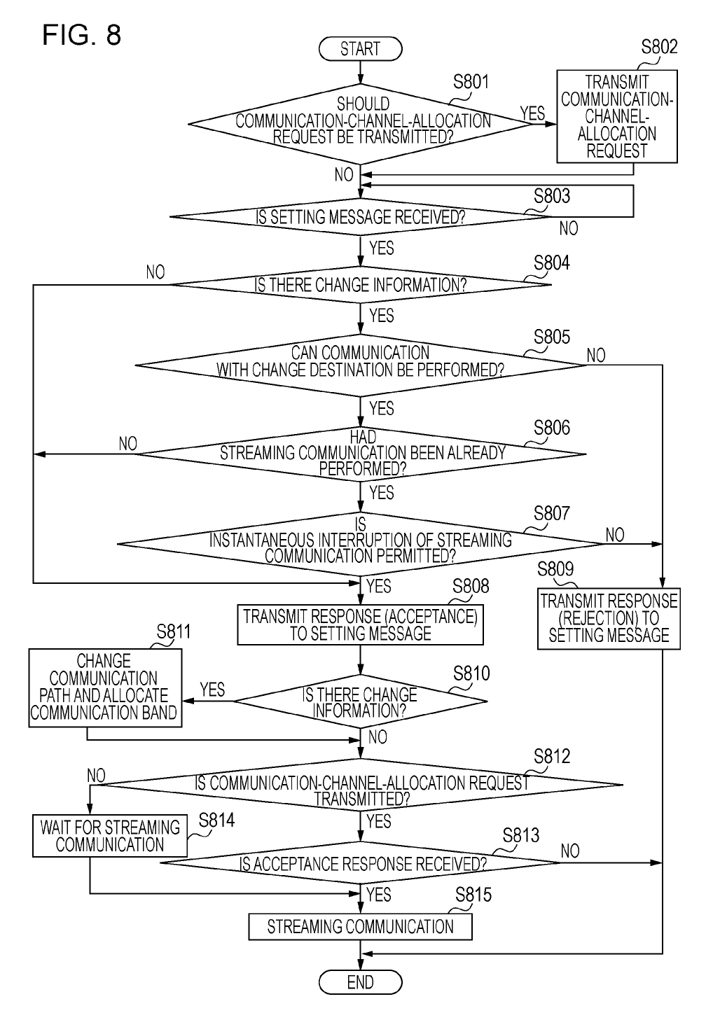

FIG. 8 is a flowchart illustrating control performed by the node control unit 315 so as to allocate the different communication channel 403. A program provided to perform the above-described control is stored in the node storage unit 314. Hereinafter, the source node 102 will be exemplarily described. However, the destination node 104 also performs control based on the same flowchart as that shown in FIG. 8.

First, at step S801, the node control unit 315 determines whether or not a request to start a different streaming communication is issued based on an instruction of the higher-layer application and/or the operation of the user and the communication-channel allocation request should be transmitted to the management apparatus 105. The transmission of the communication-channel allocation request may be performed by an apparatus or the like transmitting content data through the streaming communications, or an apparatus or the like receiving the content data.

In the above-described embodiment, the apparatus or the like transmitting the content data through the streaming communications transmits the communication-channel allocation request. In the case where the communication-channel allocation request is transmitted, the processing advances to step S802. Otherwise, the processing advances to step S803. In the above-described embodiment, it is determined that the source node 102 would transmit the communication-channel allocation request so as to transmit the content data to the destination node 104, and the processing advances to step S802.

At step S802, the node control unit 315 makes the request transmission unit 301 transmit the communication-channel allocation request.

Next, at step S803, the node control unit 315 confirms whether or not the setting reception unit 302 receives the setting message 504. If the setting message 504 is received, the processing advances to step S804.

At step S804, the node control unit 315 makes the information confirmation unit 303 confirm whether or not information about the communication-path change is set to the setting message as the change information. If the communication-path-change information is set, the processing advances to step S805. Otherwise, the processing advances to step S808. In this case, the communication-path-change information is set to the setting message 504 as the change information (step S705). Therefore, the processing advances to step S805.

At step S805, the node control unit 315 makes the communication confirmation unit 304 determine whether or not a communication can be established between the source node 102 and the access point 107 which had changed the communication path. According to the above-described determination, it is determined that the communication can be established when a beacon transmitted from the access point 107 which had changed the communication path is received, the value of the reception quality and/or the SN ratio is equal to a predetermined value or more, and information that should be shared beforehand, such as an encryption key for use, had already been shared. If the communication can be established, the processing advances to step S806. Otherwise, the processing advances to step S809.

Here, the source node 102 can communicate with the access point 107 and the processing advances to step S806.

Accordingly, it is confirmed whether or not the source node 102 can communicate with the access point 107 which had changed the communication path before the communication channel is actually changed. Therefore, it becomes possible to set a communication channel that can be actually used. Further, it becomes possible to prevent the communication from being interrupted due to the communication-channel change.

At step S806, the node control unit 315 makes the streaming determination unit 305 determine whether or not the streaming communication had already been performed by using the own node (the source node 102 in this case) as a transmission apparatus, a reception apparatus, or a relay apparatus. If a different streaming communication had been performed, the processing advances to step S807. Otherwise, the processing advances to step S808.

Since the source node 102 does not perform the streaming communication in this case, the processing advances to step S808.

At step S807, the node control unit 315 makes the instantaneous interruption determination unit 306 determine whether or not the above-described different streaming communication can be instantaneously interrupted. It is determined that the different streaming communication can be instantaneously interrupted when the value of a buffer provided in a communication apparatus provided on the reception side, the communication apparatus being used for the different streaming communication, is equal to a predetermined threshold value or more. This is because data of the different streaming communication is buffered so that even though the communication is instantaneously interrupted, content data transmitted through the streaming communication can be continuously presented to the user through a buffer on the reception side. Otherwise, the determination may be made based on the details of the content data transmitted through the streaming communication, an application provided to perform the streaming communication, or address data. If it is determined that the streaming communication can be instantaneously interrupted, the processing advances to step S808. Otherwise, the processing advances to step S809.

Accordingly, it becomes possible to change the communication channel in consideration of the different streaming communication. Further, steps S806 and S807 may be omitted. The processing load placed on the node control unit 315 is reduced by omitting steps S806 and S807.

At step S808, the node control unit 315 makes the setting response unit 307 transmit the acceptance response 506 to the management apparatus 105 as a response to the setting message, and the processing advances to step S810.

Further, at step S809, the node control unit 315 makes the setting response unit 307 transmit a rejection response to the management apparatus 105 as a response to the setting message.

At step S810, the node control unit 315 makes the information confirmation unit 303 confirm whether information about the communication path change is set to the setting message as the change information. If the communication-path change information is set, the processing advances to step S811. Otherwise, the processing advances to step S812.

Since the communication-path change information is set to the setting message 504 as the change information (step S705), the processing advances to step S811.

At step S811, the node control unit 315 changes the communication path by making the change unit 309 change the connection destination. In this case, the communication path is changed by changing the connection destination from the access point 106 to the access point 107. More specifically, disassociation defined by IEEE 802.11 is performed for the access point 106 and association defined by IEEE 802.11 is performed for the access point 107. Further, the node control unit 315 makes the band allocation unit 316 allocate a communication band based on the setting message (507).

At step S812, the node control unit 315 determines whether or not the communication-channel allocation request is transmitted to the management apparatus 105 at step S801. If the communication-channel allocation request is transmitted, the processing advances to step S813. Otherwise, the processing advances to step S814.

At step S813, the node control unit 315 confirms whether or not the request-response reception unit 312 receives a response to the communication-channel allocation request and whether or not the response indicates acceptance. If the acceptance response is received, the processing advances to step S815. In this case, the response 508 is received as a response to the communication-channel allocation request 501, and the processing advances to step S815.

At step S814, the node control unit 315 waits until the streaming communication is started. When the streaming communication is started, the processing advances to step S815.

At step S815, the node control unit 315 makes the streaming unit 313 perform the streaming communication 509 with the destination node 104 by using the different communication channel 403.

Thus, the access point is changed as the communication path change. However, the communication path change may be achieved by changing a wired path by using a virtual LAN (VLAN) or the like. Further, even though infrastructure mode has been explained in the above-described embodiment, the present invention can be used for ad-hoc mode if a management apparatus managing the network information is provided on the LAN 100.

The above-described processing procedures are performed so that the communication apparatus changes the communication path as occasion arises in synchronization with the communication-channel allocation processing. Therefore, a communication channel for which a communication band is allocated can be set over the entire area extending between the communication apparatuses (End-to-End) by using the communication-channel allocation processing as a trigger.

In the first embodiment, the destination nodes 103 and 104 are connected to the wired communication channel 108. In this embodiment, the destination nodes 103 and 104 are connected to the system via the access point 106 and/or the access point 107. Further, the descriptions of the same parts as those used in the first embodiment are omitted.

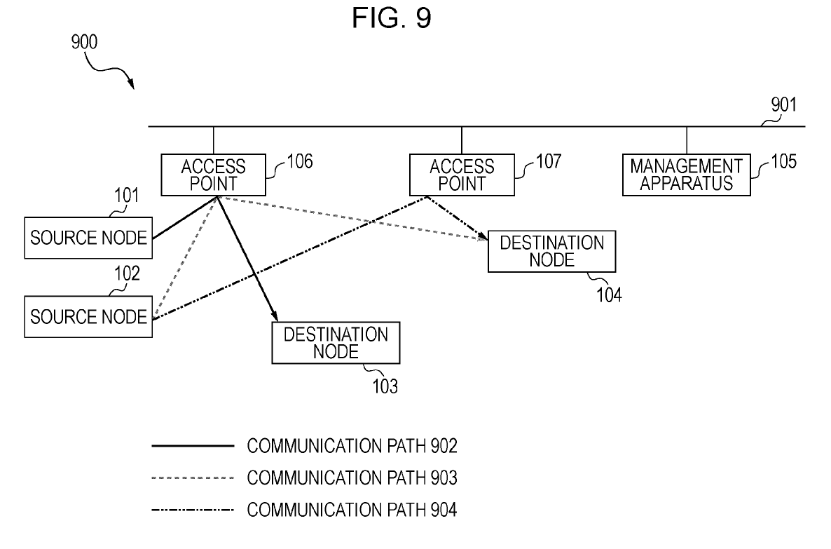

FIG. 9 shows a LAN 900 according to the above-described embodiment. Here, a wired communication channel 901 connects the management apparatus 105 and the access points 106 and 107 to one another.

A communication channel 902 extends from the source node 101 to the destination node 103 via the access point 106, where a communication band had already been allocated for the communication channel 902. The streaming communication is performed between the source node 101 and the destination node 103 through the communication channel 902.

A communication channel 903 extends from the source node 102 to the destination node 104 via the access point 106, where no communication band is allocated for the communication channel 903. The source node 102 communicates with the destination node 104 through the communication channel 903.

A different communication channel 904 is set and extended from the source node 102 to the destination node 104 via the access point 107, where a communication band is allocated for the communication channel 904. The different communication channel 904 is set due to a request for starting a different streaming communication, the request being issued in the source node 102, based on an instruction of the higher-layer application and/or the operation of the user.

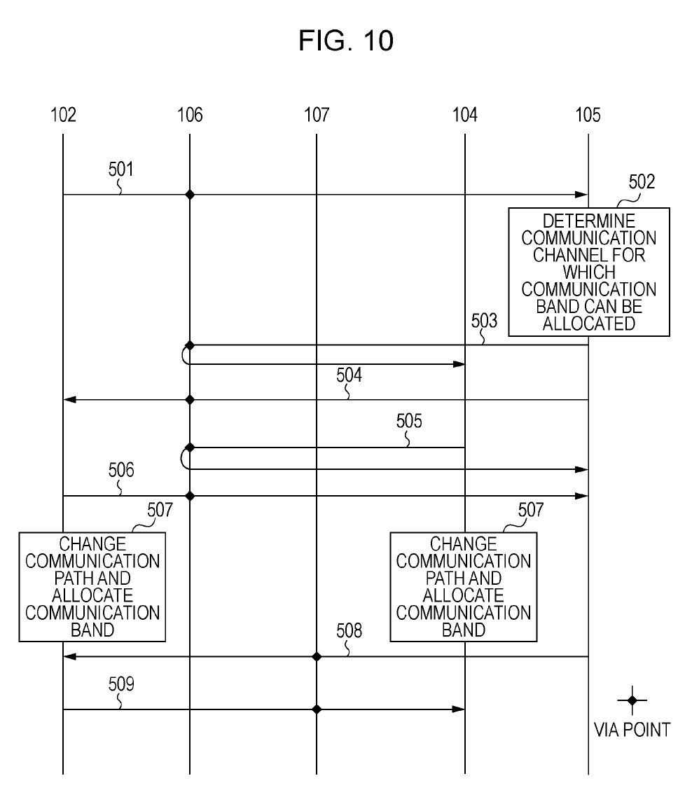

FIG. 10 shows a sequence chart illustrating an example where the different communication channel 904 is allocated. FIG. 10 is different from FIG. 5 in that the setting message 503 and the setting-message response 505 are transmitted via the access point 106. Further, FIG. 10 is different from FIG. 5 in that the destination node 104 changes the communication path based on the change information (507).

FIG. 7 is a flowchart illustrating processing procedures performed by the management-and-control unit 209 so as to read and execute a program stored in the management-and-storage unit 203 when the different communication channel 904 is allocated. The descriptions of the same processing procedures as those performed in the first embodiment are omitted.

At step S704, the management-and-control unit 209 instructs the allocation determination unit 204 to make the communication apparatus perform the change control so as to determine a communication channel for which a requested communication band can be allocated. Here, it is determined that the requested communication band can be allocated on the communication channel 904 where both the communication paths on the source-node-102 side and the destination-node-104 side are changed, and the processing advances to step S705.

At step S705, the management-and-control unit 209 makes the setting unit 205 set the change information to the setting message as the additional information. In this case, information indicating that both the communication paths on the source-node-102 side and the destination-node-104 side are changed, that is, information indicating that the access point used by both the communication apparatuses 102 and 104 is changed from the access point 106 to the access point 107 is set as the change information. Therefore, information about the communication path change is set to the setting messages 503 and 504 as the change information.

Further, the source node 102 performs the same operations as those described in the first embodiment according to a flowchart shown in FIG. 8.

Next, control performed by the node control unit 315 of the destination node 104 according to the above-described embodiment will be described with reference to the flowchart shown in FIG. 8.

At step S801, the destination node 104 of the above-described embodiment does not transmit the communication-channel allocation request to the management apparatus 105 so that the processing advances to step S803.

At step S803, the setting reception unit 302 receives the setting message 503, and the processing advances to step S804.

At step S804, the information confirmation unit 303 confirms that information about the communication path change is set to the setting message 503 as the change information, and the processing advances to step S805.

At step S805, the communication confirmation unit 304 confirms that a communication can be established between the destination node 104 and the access point 107 which had changed the communication path, and the processing advances to step S806.

At step S806, the streaming determination unit 305 determines that the streaming communication had not been performed by using the own node (the destination node 104 in this case) as a transmission apparatus or a reception apparatus or a relay apparatus, and the processing advances to step S808.

At step S808, the node control unit 315 makes the setting response unit 307 transmit the acceptance response 505 to the management apparatus 105 as a response to the setting message, and the processing advances to step S810.

At step S810, the information confirmation unit 303 confirms that the communication-path change information is set to the setting message 503 as the change information, and the processing advances to step S811.

At step S811, the communication path is changed so as to be ready for the different communication channel 904 based on the change information set to the setting message. Further, the destination node 104 allocates a communication band based on the setting message (507).

Since the destination node 104 does not transmit the communication-channel allocation request at step S812, the processing advances to step S814.

At step S814, the node control unit 315 waits until the streaming communication 509 is started. When the streaming communication 509 is started, the processing advances to step S815.

At step S815, the node control unit 315 makes the streaming unit 313 perform the streaming communication 509 with the source node 102 by using the different communication channel 904.

When both the communication apparatuses change the communication path in the above-described manner, the source node 102 which issued the request source recognizes that the communication channel is successfully allocated and starts the streaming communication.

Thus, both the source node 102 and the destination node 104 change the communication path, so as to change the communication channel. However, the communication channel change can be achieved without being limited to the above-described embodiments. For example, only the destination node 104 may change the communication path so that the access point at the connection destination is changed from the access point 106 to the access point 107.

Further, in the above-described embodiments, the access point is changed so as to change the communication channel. However, the communication path may be changed by changing the wired path by using the VLAN or the like. Further, even though infrastructure mode has been explained in the above-described embodiment, the present invention can be used for ad-hoc mode if a management apparatus managing the network information is provided on the LAN 100.

The above-described processing procedures are performed so that the communication apparatus collectively changes the communication paths as occasion arises in synchronization with the communication-channel allocation processing. Therefore, it becomes possible to set a communication channel for which a communication band is allocated over the entire area extending between the communication apparatuses (End-to-End) by using the communication-channel allocation processing as a trigger.

In the first and second embodiments, the communication-path change information is set as the change information. In the above-described embodiment, information about the reduction of a transfer rate is set to the change information. The descriptions of the same processing procedures as those performed in the first embodiment are omitted.

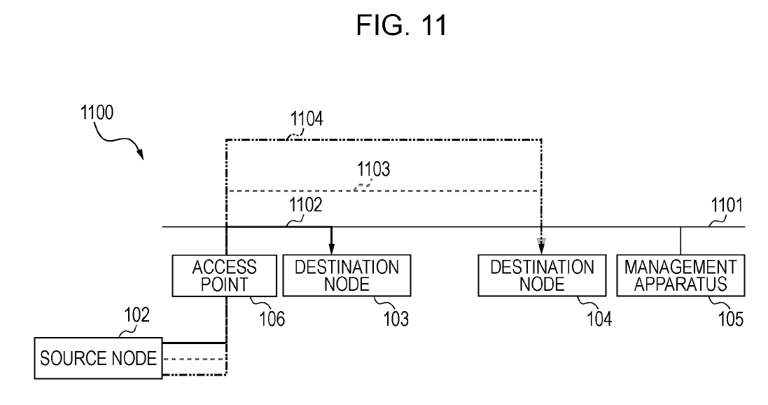

FIG. 11 shows a LAN 1100 according to the above-described embodiment. Here, a wired communication channel 1101 connects destination nodes 103 and 104, the management apparatus 105, and the access point 106 to one another.

A communication channel 1102 extends from the source node 102 to the destination node 103 via the access point 106, where no communication band is allocated for the communication channel 1102. The streaming communication is established between the source node 102 and the destination node 103 through the communication channel 1102.

A communication channel 1103 extends from the source node 102 to the destination node 104 via the access point 106, where no communication band is allocated for the communication channel 1103. A communication is established between the source node 102 and the destination node 104 through the communication channel 1102.

A different communication channel 1104 is set and extended from the source node 102 to the destination node 104 via the access point 106, where a communication band is allocated for the different communication channel 1104. The different communication channel 1104 is set due to a request for starting a different streaming communication, the request being issued in the source node 102, based on an instruction of the higher-layer application and/or the operation of the user. In the above-described embodiment, a request for setting a communication path for which a communication band of 20 Mbps is allocated is issued so that the communication path extends from the source node 102 to the destination node 104.

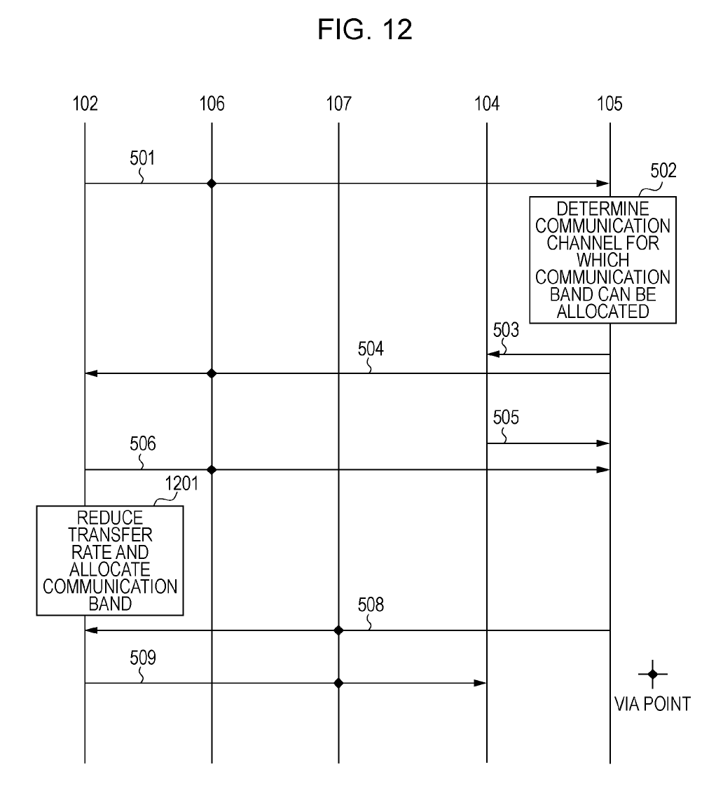

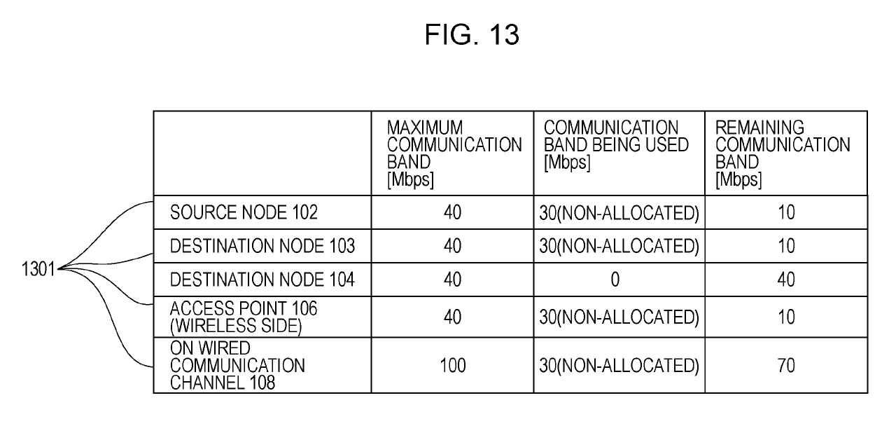

FIG. 12 shows a sequence chart illustrating an example where the different communication channel 1104 is allocated. In FIG. 12, the source node 102 performs transfer rate reduction 1201. FIG. 13 is a diagram showing the remaining communication band of each of the communication apparatuses and the access points that are provided in the LAN 100, where the information about the remaining communication bands is stored in the management-and-storage unit 203. Each of the communication apparatuses and the access points that are provided on the communication channel 1102 (1301) is used, where a communication band of 30 Mbps is not allocated for each of the communication apparatuses and the access points.

FIG. 7 is a flowchart illustrating processing procedures performed by the management-and-control unit 209 so as to read and execute a program stored in the management-and-storage unit 203 when the different communication channel 1104 is allocated. The descriptions of the same processing procedures as those performed in the first embodiment are omitted.

Next, at step S702, the management-and-control unit 209 makes the acquisition unit 202 refer to data stored in the management-and-storage unit 203 and acquire information about the remaining communication band of each of the communication apparatuses and the access points that are provided in the LAN 100, where the information is shown in FIG. 13.

Next, at step S703, the management-and-control unit 209 makes the allocation determination unit 204 determine whether or not a requested communication band can be allocated without making the source node 102 reduce a transfer rate used for a different streaming communication performed by using the communication channel 1102.

At step S704, the management-and-control unit 209 makes the allocation determination unit 204 determine a communication channel for which the requested communication band can be allocated by making the communication apparatus perform the change control. In the above-described embodiment, the allocation determination unit 204 makes the source node 102 reduce the transfer rate used for the different streaming communication performed by using the communication channel 1102. Consequently, the allocation determination unit 204 determines that the requested communication band can be allocated on the communication channel 1104. Here, it is determined that a different communication channel 1203 can be allocated by reducing the transfer rate of the communication channel 1102 for which no communication band is allocated from 30 Mbps to 20 Mbps.

At step S705, the management-and-control unit 209 makes the setting unit 205 set the change information to the setting message as the additional information. Here, the setting unit 205 sets information indicating that the transfer rate of the communication channel 1102 of the source node 102 is reduced from 30 Mbps to 20 Mbps as the change information.

Since processing procedures performed at the following steps are the same processing procedures as those performed in the first embodiment, the descriptions thereof are omitted.

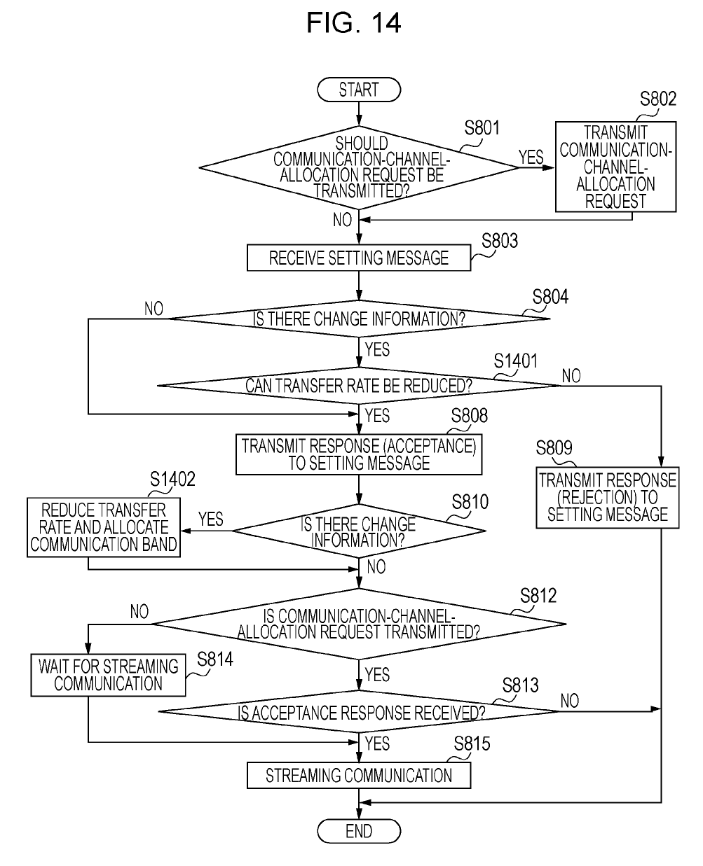

Next, FIG. 14 shows a flowchart of processing procedures performed by the source node 102 so as to allocate the different communication channel 1203. Further, the same steps as those shown in FIG. 8 described in the first embodiment are designated by the same reference numerals and the descriptions thereof are omitted.

At step S1401, the transfer rate confirmation unit 309 confirms whether or not the transfer rate of the communication channel 1102 for which no communication band is allocated can be reduced from 30 Mbps to 20 Mbps. The above-described confirmation is made by determining whether a communication band is allocated for the communication channel 1102. If the transfer rate can be reduced, the processing advances to step S808. Otherwise, the processing advances to step S809.

Here, no communication band is allocated for the streaming communication performed through the communication channel 1102. Therefore, the transfer rate of the above-described streaming communication can be reduced from 30 Mbps to 20 Mbps. Therefore, the processing advances to step S808 and the setting response unit 307 transmits the acceptance response 505 to the management apparatus 105 as a response to the setting message.

Further, at step S1402, the reduction unit 310 reduces the transfer rate of the communication channel 1102 for which no communication band is allocated from 30 Mbps to 20 Mbps. Further, the node control unit 315 makes the band allocation unit 316 allocate a communication band based on the setting message (507).

In the above-described example, a single access point is provided in the system. However, without being limited to the above-described example, the present invention can be used even though a plurality of access points is provided in the system. Further, in the above-described embodiment, the transfer rate of a communication is reduced, the communication being performed by the source node 102 provided on the communication channel 1102 without allocating a communication band of 30 Mbps. However, the present invention can be used even though a different communication apparatus provided on the communication channel 1102, such as the destination node 104, uses the communication band of 30 Mbps without allocating the same communication band. Namely, if the destination node 104 had already performed a communication without allocating the communication band of 30 Mbps, it is determined that a requested communication band can be allocated on the communication channel 1104 by reducing the transfer rate of the communication performed by the destination node 104. After that, the transfer rate of the communication that had already been performed by the destination node 104 is reduced so that the requested communication band can be allocated on the communication channel 1104.

The above-described processing procedures are performed so that the communication apparatus reduces the transfer rate of a communication for which no communication band is allocated for each communication path as occasion arises in synchronization with the communication-channel allocation processing. Therefore, it becomes possible to perform optimization control for each communication path by using the communication-channel allocation processing as a trigger.

A recording medium storing program code of software implementing the functions of the above-described embodiments constitutes another embodiment of the present invention. The present invention can be achieved by supplying the recording medium to a system and/or an apparatus, and reading and executing the program code stored in the recording medium through a computer (a CPU, a microprocessing unit (MPU), etc.) provided in the system and/or the apparatus.

The recording medium provided to supply the program code may be, for example, a flexible disk, a hard disk, an optical disk, a magneto-optical disk, a compact disk (CD)-read only memory (ROM), a CD-recordable (R), a magnetic tape, a nonvolatile memory card, a ROM, a digital-versatile disk (DVD), etc.

Further, various network management protocols including UPnP, SNMP, and so forth can be used as the protocol of a message communication performed between a communication apparatus and a management apparatus.

According to another embodiment of the present invention, processing procedures including a combination of the processing procedures shown in the flowcharts described in the first to third embodiment may be performed. For example, if it is determined that the requested communication band is not allocated on the communication channel 403 at step S704 described in the first embodiment, the processing procedures shown in the flowchart of the third embodiment may be performed so as to determine the reduction of the transfer rate of a communication that had already been performed by the communication apparatus.

For example, the management apparatus may perform both the processing procedures shown in the flowchart of the first embodiment, the processing procedures being performed to determine the communication channel change, and the processing procedures shown in the flowchart of the third embodiment, the processing procedures being performed to determine the reduction of the transfer rate of the communication that had already been performed by the communication apparatus. Further, the management apparatus may add the change information of both the first and third embodiments to the setting message.

If the communication apparatus determines that it is difficult to perform the communication at step S805 described in the first embodiment, or the instantaneous interruption is not permitted at step S807, the processing procedures shown in the flowchart of the third embodiment are performed, so as to determine the reduction of the transfer rate of the communication that had already been performed by the communication apparatus.

In that case, if the transfer rate of the communication that had already been performed by the communication apparatus is not reduced by the communication apparatus at step S1401 described in the third embodiment, the processing procedures shown in the flowchart of the first embodiment may be performed so as to determine the communication channel change.

As described above, it becomes possible to set a communication channel for which a communication band is allocated over the entire area extending between the communication apparatuses (End-to-End) even though the communication band of a communication channel that had already been formed between the communication apparatuses is insufficient. Therefore, the streaming communication can be performed with efficiency. Further, since the management apparatus makes the determination of the communication channel of the change destination, the determination of the reduction of the transfer rate of an existing communication channel, and so forth, the load placed on each of the communication apparatuses can be reduced. Consequently, an apparatus provided with not many processing resources including a small CPU capacity, a small memory, and so forth can set a communication channel for which a communication band is allocated.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-197966 filed on Jul. 31, 2008, which is hereby incorporated by reference herein in its entirety.

What is claimed is:

1. A management apparatus managing a network, the management apparatus comprising:
a receiving unit configured to receive a request to allocate a communication band on a communication channel provided between a data transmission apparatus and a data reception apparatus;
a search unit configured to search for a communication channel for which the requested communication band can be allocated; and
an instruction unit configured to instruct at least the data transmission apparatus and/or the data reception apparatus to change to the communication channel searched by the search unit.

2. A management apparatus managing a network, the management apparatus comprising:
a receiving unit configured to receive a request to allocate a communication band on a communication channel provided between a data transmission apparatus and a data reception apparatus;
a selection unit configured to select an access point that can allocate the requested communication band; and
an instruction unit configured to instruct at least the data transmission apparatus and/or the data reception apparatus to change to the access point selected by the selection unit.

3. The management apparatus according to claim 1, wherein the instruction unit transmits the change instruction when it is difficult to allocate the requested communication band on the communication channel provided between the data transmission apparatus and the data reception apparatus before the change is made.

4. The management apparatus according to claim 1, wherein the search unit makes the search based on a remaining communication band of each of at least one communication path existing on a communication channel provided between the data transmission apparatus and the data reception apparatus.

5. A management apparatus managing a network, the management apparatus comprising:
a receiving unit configured to receive a request to allocate a communication band on a communication channel provided between a data transmission apparatus and a data reception apparatus;
a determining unit configured to determine whether or not the requested communication band can be allocated on the communication channel by reducing a transfer rate of an existing communication performed by the data transmission apparatus and/or the data reception apparatus; and
an instruction unit configured to instruct the data transmission apparatus and/or the data reception apparatus performing the existing communication to reduce the transfer rate of the existing communication based on the determination made by the determining unit.

6. A communication apparatus comprising:
a receiving unit configured to receive a response to a request to allocate a communication band on a communication channel provided between a data transmission apparatus and a data reception apparatus, the request being transmitted from a management apparatus configured to manage a network;
a change unit configured to change the communication channel based on an instruction to change the communication channel when the response indicates the instruction;
an allocation unit configured to allocate a communication band of the changed communication channel; and
a communication unit configured to perform a communication by using a communication channel for which a communication band is allocated by the allocation unit.

7. The communication apparatus according to claim 6, wherein the change of the communication channel is performed by changing an access point to which the communication apparatus is connected.

8. The communication apparatus according to claim 6, wherein the communication apparatus is the data transmission apparatus and/or the data reception apparatus.

9. The communication apparatus according to claim 6, further comprising:
a determining unit configured to make a determination when the communication apparatus had already performed a communication, so as to determine whether or not the communication can be temporarily interrupted so as to achieve the change of the communication channel,
wherein the change unit performs the change of the communication channel based on the instruction on the basis of the determination made by the determining unit.

10. A communication apparatus comprising:
a receiving unit configured to receive a response to a request to allocate a communication band on a communication channel provided between a data transmission apparatus and a data reception apparatus, the request being transmitted from a management apparatus configured to manage a network;
an allocation unit configured to reduce a transfer rate of an existing communication performed by the communication apparatus based on an instruction to reduce the transfer rate when the response indicates the instruction and allocate a communication band of the communication channel; and
a communication unit configured to perform a communication by using a communication channel for which the allocation unit allocates a communication band.
